(19) United States
(12) Patent Application Publication
(10) Pub. No.: US 2004/0032531 A1
(43) Pub. Date: Feb. 19, 2004

(54) Method of generating images

(76) Inventor: Denis Mercier, Montreal (CA)

Correspondence Address: Eric Fincham, 316 Knowlton Road, Lac Brome, J0E 1V0, CA

(21) Appl. No.: 10/455,063

(22) Filed: Jun. 4, 2003

(30) Foreign Application Priority Data
Jun. 4, 2002 (CA) 2,388,949

(51) Int. Cl. H04N 15/00; H04N 7/18; H04N 9/47

(52) U.S. Cl. 348/584; 348/148; 348/46

(57) ABSTRACT

A method and system for mobile mapping wherein a single camera may be utilized, the camera taking a first image at a first time point and a second image at a second time point, each of the images having geographical coordinates associated therewith, and then generating a virtual image of an element from the first and second images.

### FIELD OF THE INVENTION

The present invention relates to a method and system for generating two simultaneous points of view from images taken by a single camera.

### BACKGROUND OF THE INVENTION

The use of cameras mounted on vehicles and the taking of a plurality of images is well known in the art. Thus, it is known that one can produce stereoscopic three dimensional images from a single motion picture video film having a plurality of frames which contain successive images produced from a single video camera in motion. The camera is displaced along an axis with a viewing axis of the camera oriented substantially perpendicular to the axis of displacement of the camera. Images are overlaid or alternated in a synchronized manner and separated by a time sequence to produce video signals of composite images which can produce 3-D images using eyeglasses conditioned to view separate ones of the overlaid or alternating images.

In U.S. Pat. No. 4,807,024, issued Feb. 21, 1989, there is disclosed an apparatus and a method for producing three dimensional images by using a single camera mounted on a platform moving at a constant velocity and spacing with respect to the subject to be imaged. The system is characterized in that the three dimensional images can be viewed without the use of special eyeglasses and that the images on the screen are displaced from the top to the bottom of the screen. The system alternates the frames of the film at an average frequency of 10 frames per second, but this could vary between 4 and 30 frames. Two work prints are placed at an optical printer and are aligned for printing with corresponding images in the two prints offset from each other by a sufficient number of frames so that the resulting print contains images that evolve in time with alternating viewpoints that differ in vertical parallax. These are thought that by employing a video camera and video processing, high quality three dimensional images may be generated in near real time and viewed without the use of special glasses or other aids.

A frequent need is for dual referencing of various physical elements such as characteristics of a border route, road signs, drainage equipment, electrical networks, telecommunication networks, and the government properties such as fire hydrants, road markers, etc.

To date, this is generally being done by utilizing a vehicle having two different cameras and the use of geographical coordinates.

### SUMMARY OF THE INVENTION

It is the object of the present invention to provide a method and a system for dual referencing of various elements utilizing a vehicle and a single camera.

According to one aspect of the present invention, there is provided a system for mobile mapping to generate an image of a desired element, the system comprising a camera designed to be mounted to a moving vehicle, geographical coordinates generating means and means for storing a first image at a first time point, the image having geographical coordinates associated therewith, means for storing a second image at a second point of time, the second image having geographical coordinates associated therewith, and means for generating a virtual image of the element from the first and second images.

In another aspect of the present invention, there is applied a method for the mobile mapping, the method comprising the steps of taking a first image at a first time, the image having geographical coordinates associated therewith, and storing the first image; taking a second image at a second point of a time, the second image having geographical coordinates associated therewith, and storing the second image, and generating a virtual image of the element.

According to the present invention, there is provided a single camera mounted on a vehicle and which camera can be mounted and directed in any desired direction. Thus, it may be moved in any of the three axes. The camera generates a certain number of images per second (the number of images can be varied). Each one of the images is associated with a specific geographical coordinate.

For viewing, pairs of images may be generated by a certain time gap which is translated by a certain number of time gap images between the two images that form the pair. Since each of the images carries geographical coordinates, it is possible to apply photogrammetric functions starting from these two images with a further image being virtually generated.

The present invention may, among other things, be utilized to generate images which permit the geo-referencing of elements located on the sides of a road—i.e. characteristics of the road, road signs, drainage equipment, power lines, telecommunication distribution networks, etc.

As aforementioned, one need only to employ a single camera to carry out the present invention. This single camera can be mounted on any mobile apparatus and would generally be mounted on a vehicle such as a automobile, truck, train, aircraft, or the alike.

The geographical coordinates which are associated with each image can be generated by many suitable means including GPS, an inertial system, or any other system which permits the generation of a geographical positioning.

Many suitable cameras may be utilized although the specific characteristics of the camera must be incorporated in the software.

The number of images generated can be variable and can be programmed either according to the vehicle speed (distance traveled) or on a time basis. The images are stored on a suitable storage medium such a hard disk using suitable software such as that known as chronos data acquisition software.

The system will also have the capability of providing an overview map of the route traveled and can also record audio comments.

Subsequently, after the mobile mapping, the data can be transferred to a computer which will run an analyst data extraction software. It will apply algorithms to process the data and to generate the virtual images. All parameters during the capture of the images are specified (the relationship (distance) of the camera and GPS), the angle of the camera relative to the movement, the type of camera, and the calibration.

The system offers functions allowing one to position and georeference elements from the camera. The system can offer functions based on a cursor which may be positioned on one element of the left image and on the right image (images separated by a time gap) and which allows the positioning of this element. The same cursor may be utilized to proceed to measurements in any desired dimension. Thus, one could include height, width, depth, areas and volumes.

It will be understood that the above described embodiment is for purposes of illustration only and changes or modifications may be made thereto without departing from the spirit and scope of the invention.

I claim:

1. A system for mobile mapping to generate an image of a desired element, said system comprising:
a camera designed to be mounted to a moving vehicle;
geographical coordinates generating means;
means for storing a first image at a first time point, said image having geographical coordinates associated therewith;
means for storing a second image at a second point of time, said second image having geographical coordinates associated therewith; and
means for generating a virtual image of said element from said first and second images.

2. A method for the mobile mapping, said method comprising the steps of:
taking a first image at a first time, said image having geographical coordinates associated therewith, and storing said first image;
taking a second image at a second point of a time, said second image having geographical coordinates associated therewith, and storing said second image; and
generating a virtual image of said element.
